(19) United States
(12) Patent Application Publication
(10) Pub. No.: US 2011/0280992 A1
(43) Pub. Date: Nov. 17, 2011

(54) TEA EXTRACT AND METHOD FOR PRODUCING SAME

(75) Inventor: Kenji Saito, Hiratsuka-shi (JP)

(73) Assignee: TAKASAGO INTERNATIONAL CORPORATION, TOKYO (JP)

(21) Appl. No.: 13/145,672

(22) PCT Filed: Jan. 7, 2010
(86) PCT No.: PCT/JP2010/050104

§ 371 Date: Jul. 21, 2011

(30) Foreign Application Priority Data
Jan. 29, 2009 (JP) 2009-018286

(51) Int. Cl. A23F 3/16; A23F 3/00

(52) U.S. Cl. 426/50; 426/52; 426/655; 426/597

(57) ABSTRACT

Provided is a method for producing a tea extract having enriched aroma by using an inexpensive enzyme without adding any chemically synthesized aroma components. A method for producing a tea extract which comprises performing a treatment with a polysaccharide-degrading enzyme simultaneously with and/or after the extraction of a tea extract from a starting tea material, wherein, in the treatment with the polysaccharide-degrading enzyme, the pH of the tea extract is 3-7 and the treatment time is 3-48 hours.

### TECHNICAL FIELD

The present invention relates to a tea extract having an odor increased by allowing an enzyme to act during or after extraction thereof.

### BACKGROUND ART

As quality improvement methods of a tea beverage or a tea extract by use of an enzyme, there have been disclosed a beverage-production method in which a green tea extract liquid is treated with β-mannanase (Patent Document 1), and a beverage-production method in which a green tea extract liquid is treated with hemicellulase (Patent Document 2) in order to prevent deposits, for example.

As methods for increasing umami taste and richness, there have been disclosed a method in which a tea leaf raw material is extracted in the presence of protease and tannase (Patent Document 3), a method in which tea leaves are subjected to an enzymatic-degradation and extraction treatment by use of an enzyme group including at least cellulase, hemicellulase, pectinase, and protopectinase (Patent Document 4), and a tea extract production method in which an enzymatic degradation treatment is conducted by use of a saccharide-degrading enzyme during and/or after extraction from a tea raw material (Patent Document 5).

However, these production methods are intended for prevention of deposit formation in long term storage, increase in umami taste, reduction in astringency, and the like, and are not satisfactory in terms of odor.

Meanwhile, as methods for increasing an odor of a tea by use of an enzyme, there have been known a production method in which a glycoside-degrading enzyme is allowed to act on an extract liquid of a green tea (Patent Document 6), a production method in which a glycoside-degrading enzyme is allowed to act on tea leaves during or after a tannase treatment (Patent Document 7), and a method in which a diglycosidase derived from a microorganism is allowed to act (Patent Document 8).

However, the glycoside-degrading enzymes used in these production methods are extremely expensive, and are disadvantageous in terms of industrial application.

Teas are roughly classified into three types depending on the degree of fermentation in their production process, namely, non-fermented teas represented by green tea, semi-fermented teas represented by oolong tea, and fully fermented teas represented by black tea, and are widely drunk all over the world. Recently, tea beverages filled in containers with an extract from tea have been developed. These tea beverages are mainly produced through the following steps. Specifically, an extract liquid is extracted from tea leaves with hot or warm water, and the extract liquid is diluted to a concentration suitable for a beverage. Thereafter, the diluted extract liquid is sterilized before or after being packaged into cans or PET bottles. After that, these beverages are stored at normal temperature or low temperature, until they reach consumers. As a result, loss in odor component is unavoidable. Hence, such beverages are unsatisfactory in terms of odor strength, when compared with those prepared from tea leaves at home.

In some cases, a flavor obtained by blending chemically synthesized odor substances may be added to compensate the loss in odor during production and storage. However, since consumers recently have been more aware of food safety and more inclined toward natural products, there is a tendency to avoid the use of flavors for, especially, tea beverages.

### PRIOR ART DOCUMENTS

### Patent Documents

[Patent Document 1] Japanese Patent Application Publication No. 2002-119209
[Patent Document 2] Japanese Patent Application Publication No. Hei 8-228684
[Patent Document 3] Japanese Patent Application Publication No. 2003-144049
[Patent Document 4] Japanese Patent Application Publication No. 2003-210110
[Patent Document 5] Japanese Patent Application Publication No. 2008-86280
[Patent Document 6] Japanese Patent Application Publication No. 2004-147606
[Patent Document 7] Japanese Patent Application Publication No. 2006-75112
[Patent Document 8] International Patent Application Publication No. WO2003/056930

### SUMMARY OF INVENTION

### Problems to be solved by the Invention

An object of the present invention is to provide a method for obtaining a tea extract having an odor increased by use of an inexpensive enzyme without blending any chemically synthesized odor substance.

### Means for Solving the Problems

The present inventors have made an earnest study to improve the flavor of a tea extract. As a result, the present inventors have found that a tea extract having an unprecedentedly strong odor can be obtained when the concentration of methyl salicylate is increased to 40 ppb or higher per percent of Brix by allowing a specific enzyme to act on a tea extract under specific conditions during or after extraction of the tea extract. This finding has led to the completion of the present invention

Specifically, the present invention provides a method for producing a tea extract, comprising performing a polysaccharide-degrading enzyme treatment during and/or after extraction of a tea extract from a raw material tea, wherein during the polysaccharide-degrading enzyme treatment, the pH of the tea extract is 3 to 7, and a treatment time is 3 to 48 hours.

Moreover, the present invention provides a tea extract obtained by performing a polysaccharide-degrading enzyme treatment during and/or after extraction of a tea extract from a raw material tea, wherein the content of methyl salicylate is 40 ppb or more per percent of Brix.

Furthermore, the present invention provides a packaged tea beverage obtained by blending therewith the tea extract obtained by the above production method or the above tea extract.

### Effects of the Invention

The present invention makes it possible to obtain a tea extract having an increased odor at low costs without blending any chemically synthesized odor substance.

### MODE FOR CARRYING OUT THE INVENTION

The present invention is characterized by performing a polysaccharide-degrading enzyme treatment during and/or after extraction of a tea extract from a raw material tea.

In the present invention, any tea can be used as the raw material tea, as long as the raw material of the tea is buds and/or leaves of a tea plant (scientific name: Camellia sinensis) of the family Theaceae. Teas include the Chinese variety (Camellia sinensis var sinensis), the Assam variety (Camellia sinensis var assamica), the Cambodian variety (Camellia sinensis var ssp. lasiocalyx), and the like. In the present invention, any of these varieties can be used. Specific examples thereof include non-fermented teas (SENCHA, KABUSECHA, GYOKURO, TENCHA, MATCHA, TAMARYOKUCHA, BANCHA, HOJICHA, KAMAIRICHA, and the like); semi-fermented teas (pouchong tea, Tieguanyin tea, oolong tea, and the like); and fermented teas (black tea, AWA-BANCHA, GOISHICHA, TOYAMA-KUROCHA, TANCHA, Pu-erh tea, and the Like). It is also possible to use one obtained by blending multiple kinds of the above-described teas at an appropriate ratio.

As for the method for extracting a tea extract from the raw material tea, an extract may be obtained from the above-described raw material tea leaves by a general method. The method may be, for example, a method in which an extract liquid is obtained by introducing tea leaves into an extraction vessel, then immersing the tea leaves in a predetermined amount of water for a certain period, and removing the used tea leaves, a method in which a predetermined amount of an extract liquid is obtained by introducing tea leaves into an extraction tank, and then feeding water to the tank at a certain flow rate, or the like. Examples of water used in the extraction include tap water, ion-exchanged water, distilled water, natural water, natural mineral water, degassed water, aqueous ascorbic acid solution, aqueous pH adjuster (including buffer solution), and the like. The amount of water used in the extraction is not particularly limited, as long as the raw material tea leaves are immersed sufficiently. In general, the amount of water is preferably 5 times or more, more preferably 10 to 50 times, further preferably 10 to 25 times of the mass of the raw material tea leaves used. The temperature of water used in the extraction is not particularly limited, as long as the extraction is possible. The temperature is generally about 4 to 95° C., and particularly preferably 30 to 90° C. The extraction time is also not particularly limited, and is generally about 1 minute to 12 hours, and particularly preferably 5 minutes to 6 hours.

The polysaccharide-degrading enzyme may be any, as long as the enzyme is capable of generating an odor and is inexpensive. However, a large amount of enzyme is required for methyl salicylate to be generated at a desired concentration. When an enzyme having a low activity is used, the amount of the enzyme used is further increased, which increases the costs. Meanwhile, when the amount of the enzyme used is reduced, a greatly extended reaction time is required. From these viewpoints, a more inexpensive enzyme having a higher activity is more preferable as the polysaccharide-degrading enzyme. Specific examples thereof include pectinase, hemicellulase, mannanase, cellulase, xylanase, arabanase, and the like, which are widely used in the industrial field as polysaccharide-degrading enzymes. The amount of the polysaccharide-degrading enzyme used varies depending on the potency thereof and reaction conditions. For example, the polysaccharide-degrading enzyme may be added in an amount ranging from 0.001 to 10% by mass on the basis of the mass of a solution to be subjected to the reaction. Note that, in the present invention, the polysaccharide-degrading enzymes may be used alone, or in combination of two or more kinds.

The pH of the tea extract during the polysaccharide-degrading enzyme treatment is 3 to 7, and preferably 4 to 5.5. The treatment time of the polysaccharide-degrading enzyme treatment is 3 to 48 hours, and preferably 10 to 24 hours. The treatment temperature of the polysaccharide-degrading enzyme treatment is preferably 10 to 60° C., and more preferably 20° C. to 50° C. When the treatment conditions are within the ranges, methyl salicylate can be generated efficiently in a sufficient amount.

Pectinase is also referred to as polygalacturonase, pectic enzyme, polymethylgalacturonase, or pectin depolymerase, and is an enzyme which hydrolyzes the α(1-4) linkage of pectinic acid, pectin, pectic acid, and the like. Moreover, in the present invention, the pectinase also includes pectin methyl esterase which hydrolyzes the methyl ester of the carboxyl group of galacturonic acid. In the present invention, wide varieties of pectinase obtained from living organisms and typified by the above-described enzymes can be used. Moreover, commercially available formulated products of pectinase may be used. Examples of the commercially available formulated products of pectinase include Sucrase (manufactured by Sankyo Co., Ltd.), Pectinex Ultra SP-L (manufactured by Novozymes), Meicelase (manufactured by Meiji Seika Kaisha, Ltd.), Ultrazym (manufactured by Novozymes), Pectinase G “Amano,” Pectinase PL “Amano,” Newlase F (these are manufactured by Amano Enzyme Inc.), Sumizyme MC (manufactured by Shin-Nihon Chemical Co., Ltd.), and the like.

Cellulase is an enzyme which has an activity to hydrolyze cellulose. Cellulose is the major constituent of the cell walls of plants, and highly hydrophilic but insoluble in water. The cellulase is not particularly limited and any kind of cellulase can be used, as long as the cellulase has an activity to degrade cellulose. Examples of commercially available formulated products of cellulase include Cellulase T “Amano,” Cellulase A “Amano” (these are manufactured by Amano Enzyme Inc.), Driselase KSM, Multifect A40, Cellulase GC220 (these are manufactured by Genencor Kyowa Co., Ltd.), Cellulase GODO-TCL, Cellulase GODO TCD-H, Vesselex, Cellulase GODO-ACD (these are manufactured by Godo Shusei Co., Ltd.), Cellulase (manufactured by Toyobo Co., Ltd.), Cell-Lyser, Cellulase XL-522 (these are manufactured by Nagase ChemteX Corporation), Cellusoft, DeniMax (these are manufactured by Novozymes), Cellulosin AC40, Cellulosin AL, Cellulosin T2 (these are manufactured by HBI Enzymes Inc.), CELLULASE “ONOZUKA” 3S, Cellulase Y-NC (these are manufactured by Yakult Pharmaceutical Industry Co., Ltd.), Sumizyme AC, Sumizyme C (these are manufactured by Shin-Nihon Chemical Co., Ltd.), ENZYLON CM, ENZYLON MCH, Bio-Hit (manufactured by Rakuto Kasei Industrial Co., Ltd.), and the like.

Hemicellulase is an enzyme which causes a reaction to hydrolyze the glycosidic bonds of hemicellulose. Hemicellulose is a generic term for water-insoluble polysaccharides, except cellulose, contained in plant tissues, and includes xylan, mannan, araban, and the like. An enzyme degrading xylan is referred to as xylanase, an enzyme degrading mannan is referred to as mannanase, and an enzyme degrading araban is referred to as arabanase. A group of these enzymes are generally referred to as hemicellulase. The enzyme used in the present invention is not particularly limited in terms of the origin thereof and the like, and any of purified enzymes and non-purified enzymes may be used. In the present invention, it is also possible to use a formulated product which is generally referred to as hemicellulase, mannanase, xylanase, or arabanase in the food industry. Specifically, it is possible to use Cellulosin TP25, Cellulosin HC, Cellulosin GM5 (these are manufactured by HBI Enzymes Inc.), Cellulase Y-NC (these are manufactured by Yakult Pharmaceutical Industry Co., Ltd.), Hemicellulase “Amano” 90 (these are manufactured by Amano Enzyme Inc.), Sumizyme ACH, Sumizyme ARS (these are manufactured by Shin-Nihon Chemical Co., Ltd.), or the like.

The tea extract obtained by the method of the present invention can be used for various foods and beverages (especially packaged ones) such as beverages, alcoholic beverages, cold and non-cold desserts, pastries, confectionery tablets, chewing gums, and the like. Specific examples thereof include beverages such as tea beverages (green tea, oolong tea, black tea, mixed teas, and the like), dairy beverages, isotonic drinks, “Near-water” drinks, energy drinks, carbonated and beverages; alcoholic beverages such as low-malt beers and cocktails; cold and non-cold desserts such as Crème caramel, Bavarian creams, jellies, yogurts, sorbets, and ice creams; pastries such as cookies and biscuits; confectionery tablets such as candies and tablets; chewing gums; and the like.

### EXAMPLES

### Green Tea Extract A

Into a column, 3.3 kg of green tea leaves were charged, and 40 kg of ion-exchanged water at 32° C. was introduced through the bottom of the column. The extract liquid was collected through the top of the column. Thus, 19.8 kg of an extract liquid having a Brix of 5.0% was obtained.

The extract liquid was filtered through a filter paper to perform solid-liquid separation, and then sterilized at 95° C. for 30 seconds. Thus, 15.8 kg of an extract having a Brix of 5.0% and a pH of 6.0 was obtained.

### Example 1

To 100 g of the green tea extract A, 0.1 g of vitamin C was added to thereby adjust the Brix to 5.1% and the pH to 5.1. Subsequently, 0.5 g of Pectinase G “Amano” (manufactured by Amano Enzyme Inc.) was added thereto, and a reaction was allowed to proceed at 40° C. for 18 hours. Subsequently, the pH was adjusted to 6.0 by using sodium hydrogencarbonate. The extract was filtered through a filter paper, and then sterilized at 80° C. for 10 minutes. Thus, an extract having a Brix of 5.2% and a pH of 6.0 was obtained.

### Example 2

The same treatment was conducted as in Example 1, except that 0.5 g of Cellulosin AC40 (cellulase) (manufactured by HBI Enzymes Inc.) was added instead of Pectinase G “Amano.” Thus, an extract having a Brix of 5.3% and a pH of 6.0 was obtained.

### Example 3

The same treatment was conducted as in Example 1, except that 0.5 g of Hemicellulase “Amano” 90 (manufactured by Amano Enzyme Inc.) was added instead of Pectinase G “Amano.” Thus, an extract having a Brix of 5.6% and a pH of 6.0 was obtained.

### Example 4

The same treatment was conducted as in Example 1, except that 0.5 g of Cellulosin GM5 (mannanase) (manufactured by HBI Enzymes Inc.) was added instead of Pectinase G “Amano.” Thus, an extract having a Brix of 5.3% and a pH of 6.0 was obtained.

### Example 5

The same treatment was conducted as in Example 1, except that 0.5 g of Cellulosin HC (xylanase) (manufactured by HBI Enzymes Inc.) was added instead of Pectinase G “Amano.” Thus, an extract having a Brix of 5.4% and a pH of 6.0 was obtained.

### Comparative Example 1

To the green tea extract A, 0.1 g of Pectinase G “Amano” (manufactured by Amano Enzyme Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 6.0 was obtained.

### Comparative Example 2

To the green tea extract A, 0.1 g of Cellulosin AC40 (cellulase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 6.0 was obtained.

### Comparative Example 3

To the green tea extract A, 0.1 g of Hemicellulase “Amano” 90 (manufactured by Amano Enzyme Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 6.0 was obtained.

### Comparative Example 4

To the green tea extract A, 0.1 g of Cellulosin GM5 (mannanase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 6.0 was obtained.

### Comparative Example 5

To the green tea extract A, 0.1 g of Cellulosin HC (xylanase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 6.0 was obtained.

### (Odor Analysis)

Into 10 g of a sample of each of the green tea extract A and the green tea extracts obtained in Examples 1 to 5 and Comparative Examples 1 to 5, 3 g of sodium chloride was dissolved, and then the mixture was extracted with 1 ml of hexane. After separation into an organic layer and an aqueous layer, the organic layer was collected, and subjected to a gas chromatography analysis under the following conditions.

Gas chromatography conditions:

Apparatus: GL Sciences Inc., GC 390

Column: GL Sciences Inc., TC-WAX 30 m×0.25 mm

Column temperature: 60° C. to 230° C.

Rate of temperature rise: 4° C./min.

Injection temperature: 250° C.

Detection temperature: 250° C.

Carrier gas: N₂

Each concentration of methyl salicylate determined under the above-described conditions was divided by the Brix value of the corresponding extract, so that the concentration of methyl salicylate per percent of Brix was investigated.

### (Sensory Evaluation)

A comparison was made among the green tea extract A and the green tea extracts obtained in Examples 1 to 5 and Comparative Examples 1 to 5 in terms of odor strength. Each extract was diluted to have a Brix of 0.2%, and evaluated by five well-trained panelists. The evaluation criteria were as follows.

### Odor:

5 Very strong

### 4 Strong

### 3 Medium

### 2 Weak

1 Very weak

TABLE 1

| | Concentration of | Result of sensory |
|---|---|---|
| | methyl salicylate per | evaluation |
| | percent of Brix (ppb) | Odor strength |
| Green tea extract A | 0 | 1.8 |
| Example 1 | 392 | 4.6 |
| Example 2 | 103 | 4.2 |
| Example 3 | 46 | 3.6 |
| Example 4 | 193 | 4 |
| Example 5 | 40 | 3.6 |
| Comparative Example 1 | 0 | 2 |
| Comparative Example 2 | 0 | 2.4 |
| Comparative Example 3 | 0 | 2.4 |
| Comparative Example 4 | 0 | 2 |
| Comparative Example 5 | 0 | 2 |

As is shown in Table 1, the concentration of methyl salicylate in each of the products of the present invention was dramatically increased in contrast to the cases of the green tea extract A and Comparative Examples. Along with this increase, sensory aspects were such that each of the products of the present invention had a strong odor and an excellent flavor. The concentration of methyl salicylate was unchanged under the reaction conditions of each of Comparative Examples, and the sensory aspects were unsatisfactory.

### <Oolong Tea Extract A>

Into a column, 4.0 kg of oolong tea leaves were charged, and 36 kg of ion-exchanged water at 70° C. was introduced through the bottom of the column. The extract liquid was collected through the top of the column. Thus, 24 kg of an extract liquid having a Brix of 5.0% was obtained.

The extract liquid was filtered through a filter paper to perform solid-liquid separation, and then sterilized at 95° C. for 30 seconds. Thus, 20 kg of an extract having a Brix of 5.0% and a pH of 5.2 was obtained.

### Example 6

To 100 g of the oolong tea extract A, 0.5 g of Pectinase G “Amano” (manufactured by Amano Enzyme Inc.) was added, and a reaction was allowed to proceed at 50° C. for 18 hours. Subsequently, the extract was filtered through a filter paper, and then sterilized at 80° C. for 10 minutes. Thus, an extract having a Brix of 4.7% and a pH of 5.0 was obtained.

### Example 7

The same treatment was conducted as in Example 6, except that 0.5 g of Cellulosin AC40 (cellulase) (manufactured by HBI Enzymes Inc.) was added instead of Pectinase G “Amano.” Thus, an extract having a Brix of 5.2% and a pH of 4.9 was obtained.

### Example 8

The same treatment was conducted as in Example 6, except that 0.5 g of Hemicellulase “Amano” 90 (manufactured by Amano Enzyme Inc.) was added instead of Pectinase G “Amano.” Thus, an extract having a Brix of 5.4% and a pH of 4.8 was obtained.

### Example 9

The same treatment was conducted as in Example 6, except that 0.5 g of Cellulosin GM5 (mannanase) (manufactured by HBI Enzymes Inc.) was added instead of Pectinase G “Amano.” Thus, an extract having a Brix of 5.2% and a pH of 4.8 was obtained.

### Example 10

The same treatment was conducted as in Example 6, except that 0.5 g of Cellulosin HC (xylanase) (manufactured by HBI Enzymes Inc.) was added instead of Pectinase G “Amano.” Thus, an extract having a Brix of 5.4% and a pH of 5.0 was obtained.

### Comparative Example 6

To the oolong tea extract A, 0.1 g of Pectinase G “Amano” (manufactured by Amano Enzyme Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 5.0 was obtained.

### Comparative Example 7

To the oolong tea extract A, 0.1 g of Cellulosin AC40 (cellulase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 5.0 was obtained.

### Comparative Example 8

To the oolong tea extract A, 0.1 g of Hemicellulase “Amano” 90 (manufactured by Amano Enzyme Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 5.0 was obtained.

### Comparative Example 9

To the oolong tea extract A, 0.1 g of Cellulosin GM5 (mannanase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 5.0 was obtained.

### Comparative Example 10

To the oolong tea extract A, 0.1 g of Cellulosin HC (xylanase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 5.0 was obtained.

### (Odor Analysis and Sensory Evaluation)

Odor analysis and sensory evaluation were conducted on the oolong tea extract A, and the oolong tea extracts obtained in Examples 6 to 10 and Comparative Examples 6 to 10. The analysis method and the sensory evaluation criteria were the same as those of Examples 1 to 5.

TABLE 2

| | Concentration of | Result of sensory |
|---|---|---|
| | methyl salicylate per | evaluation |
| | percent of Brix (ppb) | Odor strength |
| Oolong tea extract A | 8 | 3 |
| Example 6 | 214 | 4.8 |
| Example 7 | 162 | 4.2 |
| Example 8 | 80 | 4.4 |
| Example 9 | 230 | 4 |
| Example 10 | 76 | 4.2 |
| Comparative Example 6 | 16 | 2 |
| Comparative Example 7 | 6 | 2.4 |
| Comparative Example 8 | 7 | 2.4 |
| Comparative Example 9 | 10 | 1.8 |
| Comparative Example 10 | 5 | 2 |

As is shown in Table 2, the concentration of methyl salicylate in each of Examples 6 to 10 was remarkably increased when compared with that of the oolong tea extract A before the reaction. Along with this increase, the sensory evaluation showed results indicating strong odors. On the other hand, the results of each of Comparative Examples 6 to 10 were such that the concentration of methyl salicylate was less than 40 ppb per percent of Brix, and the enzyme treatment rather weakened the odor.

### <Black Tea Extract A>

Into a column, 4.0 kg of black tea leaves were charged, and 36 kg of ion-exchanged water at 70° C. was introduced through the bottom of the column. The extract liquid was collected through the top of the column. Thus, 24 kg of an extract liquid having a Brix of 5.0% and a pH of 4.7 was obtained.

The extract liquid was filtered through a filter paper to perform solid-liquid separation, and then sterilized at 95° C. for 30 seconds. Thus, 20 kg of an extract having a Brix of 5.0% was obtained.

### Example 11

To 100 g of the black tea extract A, 0.5 g of Pectinase G “Amano” (manufactured by Amano Enzyme Inc.) was added, and a reaction was allowed to proceed at 50° C. for 18 hours. Subsequently, the extract was filtered through a filter paper, and then sterilized at 80° C. for 10 minutes. Thus, an extract having a Brix of 4.7% and a pH of 4.7 was obtained.

### Example 12

The same treatment was conducted as in Example 11, except that 0.5 g of Cellulosin AC40 (cellulase) (manufactured by HBI Enzymes Inc.) was added instead of Pectinase G “Amano.” Thus, an extract having a Brix of 5.1% and a pH of 4.6 was obtained.

### Example 13

The same treatment was conducted as in Example 11, except that 0.5 g of Hemicellulase “Amano” 90 (manufactured by Amano Enzyme Inc.) was added instead of Pectinase G “Amano.” Thus, an extract having a Brix of 5.1% and a pH of 4.6 was obtained.

### Example 14

The same treatment was conducted as in Example 11, except that 0.5 g of Cellulosin GM5 (mannanase) (manufactured by HBI Enzymes Inc.) was added instead of Pectinase G “Amano.” Thus, an extract having a Brix of 5.0% and a pH of 4.6 was obtained.

### Example 15

The same treatment was conducted as in Example 11, except that 0.5 g of Cellulosin HC (xylanase) (manufactured by HBI Enzymes Inc.) was added instead of Pectinase G “Amano.” Thus, an extract having a Brix of 5.4% and a pH of 4.6 was obtained.

### Comparative Example 11

To the black tea extract A, 0.1 g of Pectinase G “Amano” (manufactured by Amano Enzyme Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 4.6 was obtained.

### Comparative Example 12

To the black tea extract A, 0.1 g of Cellulosin AC40 (cellulase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 4.7 was obtained.

### Comparative Example 13

To the black tea extract A, 0.1 g of Hemicellulase “Amano” 90 (manufactured by Amano Enzyme Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 4.7 was obtained.

### Comparative Example 14

To the black tea extract A, 0.1 g of Cellulosin GM5 (mannanase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 4.6 was obtained.

### Comparative Example 15

To the black tea extract A, 0.1 g of Cellulosin HC (xylanase) (manufactured by HBI Enzymes Inc.) was added, and a reaction was allowed to proceed at 40° C. for 1 hour. The mixture was filtered, and then the filtrate was sterilized at 80° C. for 10 minutes. Thus, an extract having a Brix of 5.0% and a pH of 4.6 was obtained.

### (Odor Analysis and Sensory Evaluation)

Odor analysis and sensory evaluation were conducted on the black tea extract A, and the black tea extracts obtained in Examples 11 to 15 and Comparative Examples 11 to 15. The analysis method and the sensory evaluation criteria were the same as those of Examples 1 to 5.

TABLE 3

| | Concentration of | Result of sensory |
|---|---|---|
| | methyl salicylate per | evaluation |
| | percent of Brix (ppb) | Odor strength |
| Black tea extract A | 24 | 2.4 |
| Example 11 | 240 | 3.8 |
| Example 12 | 147 | 3.8 |
| Example 13 | 135 | 4.2 |
| Example 14 | 218 | 4.4 |
| Example 15 | 64 | 3.8 |
| Comparative Example 11 | 18 | 2.4 |
| Comparative Example 12 | 15 | 2.6 |
| Comparative Example 13 | 16 | 2.2 |
| Comparative Example 14 | 16 | 2.2 |
| Comparative Example 15 | 14 | 2.2 |

As is shown in Table 3, the concentration of methyl salicylate in each of Examples 11 to 15 was remarkably increased when compared with that of the black tea extract A before the reaction. Along with this increase, the sensory evaluation showed results indicating strong odors. On the other hand, the results of each of Comparative Examples 11 to 15 were such that the concentration of methyl salicylate was less than 24 ppb per percent of Brix of the black tea extract A. The results of the sensory evaluation were such that no remarkable difference in odor strength was observed between the Comparative Examples 11 to 15 and the black tea extract A.

1-5. (canceled)

6. A method for producing a tea extract, comprising performing a polysaccharide-degrading enzyme treatment during and/or after extraction of a tea extract from a raw material tea, wherein
during the polysaccharide-degrading enzyme treatment, the pH of the tea extract is 3 to 7, and the treatment time is 3 to 48 hours.

7. The production method according to claim 6, wherein
the polysaccharide-degrading enzyme is selected from the group consisting of pectinase, cellulase, hemicellulase, mannanase, xylanase, arabanase, and mixtures thereof.

8. The production method according to claim 6, wherein
the treatment temperature of the polysaccharide-degrading enzyme treatment is 10 to 60° C., and the treatment time thereof is 10 to 24 hours.

9. A tea extract obtained by performing a polysaccharide-degrading enzyme treatment during and/or after extraction of a tea extract from a raw material tea, wherein
the content of methyl salicylate is 40 ppb or more per percent of Brix.

10. A packaged tea beverage obtained by blending therewith the tea extract obtained by the production method according to claim 6.

11. A packaged tea beverage obtained by blending therewith the tea extract according to claim 9.
